(19) United States
(12) Patent Application Publication
(10) Pub. No.: US 2016/0021382 A1
(43) Pub. Date: Jan. 21, 2016

(54) METHOD FOR ENCODING AND DECODING VIDEO USING INTRA-PREDICTION COMBINED BETWEEN LAYERS

(71) Applicant: ELECTRONICS AND TELECOMMUNICATIONS RESEARCH INSTITUTE, Daejeon (KR)

(72) Inventors: Jin Ho LEE, Daejeon (KR); Jung Won KANG, Daejeon (KR); Ha Hyun LEE, Seoul (KR); Jin Soo CHOI, Daejeon (KR); Jin Woong KIM, Daejeon (KR)

(21) Appl. No.: 14/782,246

(22) PCT Filed: Apr. 4, 2014
(86) PCT No.: PCT/KR2014/002940

§ 371 Date: Oct. 2, 2015

(30) Foreign Application Priority Data
Apr. 5, 2013 (KR) 10-2013-0037626
Apr. 4, 2014 (KR) 10-2014-0040776

(51) Int. Cl. H04N 19/50; H04N 19/17; H04N 19/176; H04N 19/44

(52) U.S. Cl. CPC H04N 19/50; H04N 19/44; H04N 19/17; H04N 19/176

(57) ABSTRACT

The present invention is related to an apparatus and/or a method for image encoding and/or decoding using inter-layer combined intra prediction. The apparatus comprises a reference sample generation module generating a reference sample by using at least one of samples which is included in the reconstructed block neighboring the target block of the higher layer, a sample included in the co-located block of the lower layer corresponding to the target block of the higher layer, a sample included in the co-located block of the lower layer corresponding to the reconstructed block neighboring the target block of the higher layer, and a sample included in a certain specific block of the lower layer; a prediction performance module generating a prediction value for the target block using the reference sample; and a prediction value generation module generating a final prediction value for the prediction target block using the prediction value.

### BACKGROUND OF THE INVENTION

1. Field of the Invention

The present invention is related to a method for encoding and decoding video and an apparatus for the same and more particularly, a method and an apparatus for using the corresponding information of the reference picture to the reference inter-layer for generating the prediction sample for the encoding or decoding target block of the current layer.

2. Discussion of the Related Art

Recently, many users have been accustomed to the images of high resolution and high quality with the broadcasting service that serves High Definition (HD) resolution being expanded throughout the world as well as in this country, and thus many organizations spur the development of the next generation imaging device. Also, as the interest on the Ultra High Definition (UHD) that has more than quadruple resolution of the HDTV along with the HDTV has been increased, the compression technique for the higher resolution and quality of the image has been required.

For the image compression, many techniques such as the inter picture prediction technique that predicts the pixel value which is included in the current picture from the previous and/or subsequent picture in chronological order, the intra picture prediction technique that predicts the pixel value which is included in the current picture using the pixel information in the current picture, the entropy encoding technique that allocates short code to the symbol whose appearance frequency is high and allocates long code to the symbol whose appearance frequency is low, and so on may be utilized.

In the image compression technique, there exists the technique that provides predetermined network bandwidth under the limited operation environment of the hardware without consideration of the floating network environment. However, new compression technique is required to compress the image data which is applied to the network environment whose bandwidth is frequently changed, and for this, the scalable video encoding/decoding method may be used.

Also, increased is the demand on effective transmission of data to various transmission environment and various terminals by generating a unified data which is able to support various spatial resolution and various frame-rate.

### SUMMARY OF THE INVENTION

The present invention, to solve the problem of the prior art described above, may perform the combined prediction by using the reconstructed sample neighboring the target block or the samples of the lower layer, in performing the intra picture prediction for the target block of the higher layer. That is, the object of the present invention is to improve the coding efficiency by minimizing the prediction error, which is accomplished by combining the prediction value using the information of the higher layer and the prediction value using the information of the lower layer.

The object of the present invention is also to provide a method and an apparatus which are able to perform the prediction using the information of the other layer by adding the decoded picture of the lower layer (reference layer) to the reference picture list for the encoding/decoding target in the current layer.

The object of the present invention is to provide a method and an apparatus for generating the prediction signal difference between the original signal and the prediction signal by performing prediction (for example, a motion prediction) on the decoded picture of the lower layer (reference layer).

The object of the present invention is to provide a method and an apparatus for adaptively determining the location in the reference picture list of the decoded picture of the lower layer (reference layer) by using an coding information, the depth information of the prediction structure, and the like, when adding the decoded picture of the lower layer (reference layer) to the reference picture list for the current encoding/decoding target block.

According to an aspect of the present invention, an apparatus for decoding image using an inter-layer combined intra prediction, the apparatus may comprise a reference sample generation module generating a reference sample by using at least one of samples which is included in the reconstructed block neighboring the target block of the higher layer, a sample which is included in the co-located block of the lower layer that corresponds to the target block of the higher layer, a sample which is included in the co-located block of the lower layer that corresponds to the reconstructed block neighboring the target block of the higher layer, and a sample which is included in a certain specific block of the lower layer; a prediction performance module generating a prediction value for the target block using the reference sample; and a prediction value generation module generating a final prediction value for the prediction target block using the prediction value.

As another embodiment, wherein a filter may be applied to the reference sample in case that the reference sample is generated by not using the block of the lower layer, and wherein the filter may not be applied to the reference sample in case that the reference sample is generated by using the block of the lower layer.

As another embodiment, the reference sample may be generated according to combination of the samples. And the combination of the samples may be performed by combining two or more samples by applying an operation including addition, subtraction, multiplication, division and shift.

As another embodiment, the samples may be combined by differently applying weighting to each sample value in case of combining the samples which is included in the block of the reference sample generation module.

As another embodiment, a filter may not be applied to the reference sample.

The prediction performance module may perform one or more predictions including a prediction using the reference sample of the higher layer, a prediction using the reference sample of the lower layer, a prediction using the sample which is generated to combine the reference sample of the higher layer and the reference sample of the lower layer, and a prediction using the co-located block of the lower layer that corresponds to the target block of the higher layer.

As another embodiment, a filter may not be applied to the boundary prediction value of the block which is predicted in case of using the reference sample of the lower layer or in case of using the combined reference sample.

The prediction value generation module may generate the final prediction value by combining two or more prediction value which is generated in the prediction performance module.

As another embodiment, when combining two or more prediction values, the prediction values may be combined by differently applying weighting to each prediction value.

According to another aspect of the present invention, a method for encoding and/or decoding image using an intra picture prediction which is combined among layers, the method may comprise generating a reference sample by using at least one of samples which is included in the reconstructed block neighboring the target block of the higher layer, a sample which is included in the co-located block of the lower layer that corresponds to the target block of the higher layer, a sample which is included in the co-located block of the lower layer that corresponds to the reconstructed block neighboring the target block of the higher layer, and a sample which is included in a certain specific block of the lower layer; performing prediction by generating a prediction value for the target block using the reference sample; and generating a final prediction value for the prediction target block using the prediction value.

As another embodiment, wherein a filter may be applied to the reference sample in case that the reference sample is generated by not using the block of the lower layer, and wherein the filter may not be applied to the reference sample in case that the reference sample is generated by using the block of the lower layer.

As another embodiment, the reference sample may be generated according to combination of the samples. And the combination of the samples may be performed by combining two or more samples by applying an operation including addition, subtraction, multiplication, division and shift.

As another embodiment, the samples may be combined by differently applying weighting to each sample value in case of combining the samples.

As another embodiment, a filter is not applied to the reference sample.

The performing the prediction may perform one or more predictions including a prediction using the reference sample of the higher layer, a prediction using the reference sample of the lower layer, a prediction using the sample which is generated to combine the reference sample of the higher layer and the reference sample of the lower layer, and a prediction using the co-located block of the lower layer that corresponds to the target block of the higher layer.

As another embodiment, a filter may not be applied to the boundary prediction value of the block which is predicted in case of using the reference sample of the lower layer or in case of using the combined reference sample.

The performing the prediction may generate the final prediction value by combining two or more prediction value which is generated in the prediction performance module.

As another embodiment, when combining two or more prediction values, the prediction values may be combined by differently applying weighting to each prediction value.

### BRIEF DESCRIPTION OF THE DRAWINGS

The accompanying drawings, which are included to provide a further understanding of the present invention and constitute a part of specifications of the present invention, illustrate embodiments of the present invention and together with the corresponding descriptions serve to explain the principles of the present invention.

FIG. 1 is a block diagram illustrating the implementation of an image encoding apparatus according to an embodiment of the present invention.

FIG. 2 is a block diagram illustrating the configuration of the video decoding apparatus according to an embodiment.

FIG. 3 is a drawing for describing an embodiment of the process of intra picture prediction.

FIG. 4 is a drawing for describing an embodiment of the process of the intra picture prediction.

FIG. 5 is a block diagram illustrating the image decoding apparatus according to an embodiment.

FIG. 6A is a schematic view illustrating briefly the operation of the reference sample generation module that performs prediction of the target block according to an embodiment of the present invention.

FIG. 6B is a schematic view illustrating briefly the operation of the reference sample generation module that performs prediction of the target block according to an embodiment of the present invention.

FIG. 7 shows an embodiment of performing the intra picture prediction by using the reference sample which is generated according to the present invention.

FIG. 8 shows another embodiment of performing the intra picture prediction by using the reference sample which is generated according to the present invention.

FIG. 9 is a drawing briefly describing an embodiment of generating the final prediction value by combining the prediction value generated according to the present invention.

FIG. 10 shows another embodiment of generating the final prediction value by combining the prediction value which is generated according to the present invention.

FIG. 11 is a flowchart describing an embodiment of the image encoding and/or decoding method using the intra picture prediction which is combined between layers according to the present invention.

### DETAILED DESCRIPTION OF THE INVENTION

The inventive subject matter now will be described more fully hereinafter with reference to the accompanying drawings, in which embodiments of the present invention are shown.

In describing embodiments of the present invention, if the detailed description for the related known elements or functions may depart from the subject matter of the present invention, the detailed description may be omitted.

It will be understood that when an element is referred to as being “connected” or “accessed” to another element, it can be directly connected or got accessed to the other element or intervening elements may be exist. It will be further understood that a specific element is referred to as being “include” does not mean the exclusion of the element which is not included in the corresponding features, but additional elements may be included in the scope of the embodiment of the present invention or the technical principles of the present invention.

It will be understood that, although the terms first, second, etc. may be used herein to describe various elements, the above elements should not be limited by these terms. These terms are only used to distinguish one element from another. For example, a first element can be termed a second element, and similarly, a second element can be termed a first element without departing from the teachings of the present invention.

Also, the elements shown in the embodiments of the present invention are independently illustrated for representing distinctive functions which are different from each other, and do not signify that each of the elements is composed of a unit of separate hardware or a software. That is, each element is included with being recited for the convenience of description, at least two elements may combine to one element, or an element may be divided into plural elements and perform the functions, and the embodiment of the each element combined and the embodiment of the each element divided are included in the scope of the right of the present invention, unless they are diverged from the substance of the present invention.

Also, a part of the elements may be a selective element only for improving the performance, not an essential element performing a substantive function in the present invention. The present invention may be implemented by including essential elements which are indispensable to implement the substance of the present invention excluding the element only for improving the performance, and the structure including only the essential elements excluding selective the element only for improving the performance is also included in the scope of the right of the present invention.

The present invention is related to the technology of image encoding and decoding of the structure including multi-layers, and more particularly to a method and an apparatus for performing prediction for the higher layer by using the information of the lower layer in case of encoding/decoding the higher layer (current layer, hereinafter, it is called ‘current layer’).

In more particular, when generating the reference picture list which is used for the motion prediction of the encoding/decoding target picture of the higher layer (current layer), the reference picture list may be generated by including the decoded picture of the lower layer (reference layer).

When generating the reference picture list of the higher layer including the decoded picture of the lower layer (reference layer), the encoding efficiency may be increased by adaptively adding the decoded picture of the lower layer (reference layer, hereinafter, it is called ‘reference layer’) by using the coding information and the depth information of the prediction structure.

The present invention is related to image encoding/decoding including multiple layers and/or views, and the multiple layers or views may be represented as the first, the second, the third and the n^{th} layer or the view. In the following description, the image in which the first layer and the second layer exist will be described as an example, and the same method may be applied to more than the layer or the view. Also, the first layer may be represented as a base layer, and the second layer may be represented as an enhancement layer.

The picture/block of the lower layer that corresponds to the picture/block of the higher layer may be changed to fit the size of the picture/block of the higher layer. That is, in case that the size of the picture/block of the lower layer is smaller than the picture/block of the higher layer, it may be scaled by using the method such as up-sampling. In the following description, it may be assumed that the size of the picture/block of the lower layer is rescaled to fit the size of the picture/block of the higher layer.

It may be transmitted to the decoder by signaling whether the present invention is used or not. For example, the flag bit, ‘combined_intra_pred_flag’ may be transmitted. In case that the value of ‘combined_intra_pred_flag’ is transmitted by ‘1’, it may be represented to use the intra picture prediction method which is combined, and in case that the value of ‘combined_intra_pred_flag’ is transmitted by ‘0’, it may be represented to perform the common intra picture prediction that does not use the intra picture prediction method which is combined. In this time, the flag may be transmitted through at least one of VPS (video parameter set), SPS (sequence parameter set), PPS (picture parameter set), Slice header, and so on, or transmitted by the unit of CU (coding unit), PU (prediction unit) or TU (transform unit).

Additionally, whether the method of the present invention is applied or not may depend on the block size, the intra picture prediction mode or the luminance/chrominance signal. That is, it may be applied to a specific block size or to a specific intra picture prediction mode only. Or, it may be applied to the luminance signal, and may not be applied to the chrominance signal.

Additionally, for applying the method of the present invention, in case that weighting is applied, the corresponding information of the weighting may be transmitted by using a method among the methods of transmitting the flag.

The intra picture prediction may perform directional prediction or non-directional prediction by using at least one or more of the reconstructed reference samples.

Hereinafter, the present invention will be described in detail by referring figures.

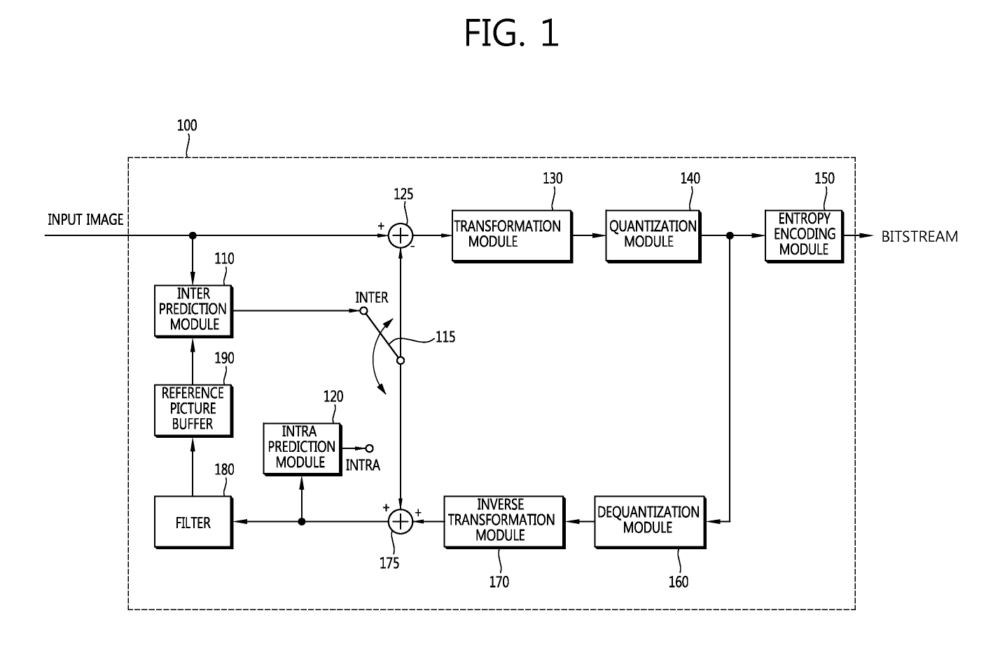

FIG. 1 is a block diagram illustrating the implementation of an image encoding apparatus according to an embodiment of the present invention.

The scalable video encoding/decoding apparatus for the multi-layer structure may be implemented by extension of the video encoding/decoding apparatus for the single-layer structure.

FIG. 1 shows an embodiment of the apparatus for encoding video which is applicable to the multi-layer structure, that is, able to provide scalability.

Referring to FIG. 1, the video encoding apparatus 100 includes an inter prediction module 110, an intra prediction module 120, a switch 115, a subtraction module 125, a transformation module 130, a quantization module 140, an entropy encoding module 150, an dequantization module 160, an inverse transformation module 170, an adding module 175, a filter module 180 and a reference picture buffer 190.

The video encoding apparatus 100 may perform encoding with the intra mode or the inter mode for the input image, and may output the bitstream. The intra prediction means an intra picture prediction, and the inter prediction means an inter picture prediction. In case of the intra mode, the switch 115 is transferred to the intra mode, and in case of the inter mode, the switch 115 is transferred to the inter mode. The video encoding apparatus 100 may encode the difference between the current block and the predicted block after generating the prediction block for the block (current block) of the input picture.

In case of the intra mode, the intra prediction module 120 may utilize the pixel value of the block which is already encoded around the current block as a reference pixel. The intra prediction module 120 may perform the spatial prediction by using a reference pixel and may generate prediction samples for the current block.

In case of the inter mode, the inter prediction module 110 may obtain a motion vector that specifies the reference block of which the difference from the input block (the current block) is the smallest in the reference picture which is stored in the reference picture buffer 190. The inter prediction module 110 may generate a prediction block for the current block by performing the motion compensation using the reference picture stored in the motion vector and the reference picture buffer 190.

In case of the multi-layer structure, the inter prediction applied in the inter mode may include the inter-layer prediction. The inter prediction module 110 may configure the inter-layer reference picture by sampling the picture of the reference layer, and may perform the inter-layer prediction by including the inter-layer reference picture in the reference picture list. The reference relationship between layers may be signaled through the information which specifies the dependence between the layers.

Meanwhile, in case that the current layer picture and the reference layer picture have the same size, the sampling applied to the reference layer picture may mean the formation of the reference sample by the sample copy or the interpolation from the reference layer picture. In case that the resolution between the current layer picture and the reference layer picture is different, the sampling which is applied to the reference layer picture may mean the up-sampling.

For example, as another case of the resolution among layers being different, the inter-layer reference picture may be configured by performing the up-sampling on the reconstructed picture of the reference layer among layers which supports the scalability for the resolution.

It may be determined by considering the encoding cost and the like which layer of picture may be used to configure the inter-layer reference picture. The encoding apparatus may transmit the information which specifies the layer to which the picture used as an inter-layer reference picture belongs to a decoding apparatus.

Also, the layer which is referred when performing the inter-layer prediction, that is, the picture which is used for predicting the current block in the reference layer may be the picture of the same Access Unit (AU) of the current picture (the prediction target picture in the current layer).

The subtraction unit 125 may generate a residual block (a residual signal) according to the difference between the current block and the prediction block.

The transformation module 130 may output a transform coefficient by performing the transform for the residual block. In case that a transform skip mode is applied, the transformation module 130 may omit the transform for the residual block.

The quantization module 140 may output a quantized coefficient by quantizing the transform coefficient according to the quantization parameter.

The entropy encoding module 150 may output a bitstream by entropy encoding of the output values from the quantization module 140 or the value of an encoding parameter and the like which is obtained during the encoding process according to the probability distribution. The entropy encoding module 150 may perform entropy encoding of the information for the video decoding (for example, the syntax element, etc.) as well as the pixel information of the video.

The encoding parameter is the information which is necessary for encoding and decoding, and may include the information which can be inferred during the process of encoding or decoding as well as the information transmitted to the decoding apparatus after being decoded in the encoding apparatus such as the syntax element.

The encoding parameter may include the value or the statistics, for example, intra/inter prediction mode, displacement/motion vector, reference picture index, coding block pattern, presence of the residual signal, transform coefficient, quantized transform coefficient, quantization parameter, size of block, block partition information and the like.

The residual signal may mean the difference between the original signal and the prediction signal or may mean the signal having the form which the difference between the original signal and the prediction signal are transformed or may means the signal having the form of the difference between the original signal and the prediction signal are transformed and quantized. The residual signal may be referred to the residual block in the block unit.

In case of the entropy encoding being applied, the small number of bits is allocated to the symbol which has high generation probability and the large number of bits is allocated to the symbol which has low generation probability, thus, the size of the bit low for the encoding target symbols may be decreased. Accordingly, the performance of compression of the image encoding may be increased through the entropy encoding.

For the entropy encoding, the method of encoding such as exponential golomb, Context-Adaptive Variable Length Coding (CAVLC), Context-Adaptive Binary Arithmetic Coding (CABAC) may be used. For example, the entropy encoding module 150 may perform entropy encoding by using Variable Length Coding/Code (VLC) table. Also, the entropy encoding module 150 may perform entropy encoding by using the binarization method or the probability model after coming up with the binarization method of the target symbol and probability model of the target symbol/bin.

The quantized coefficient may be inversely quantized at the dequantization module 160 and may be inversely transformed at the inverse transformation module 170. The coefficient inversely quantized and inversely transformed may be added to the prediction block through the adding module 175, and then the reconstruction block may be generated.

The reconstructed block passes the filter module 180, and the filter module 180 may apply at least one of deblocking filter, Sample Adaptive Offset (SAO) and Adaptive Loop Filter (ALF) to the reconstructed block or the reconstructed picture. The reconstructed block passing through the filter module 180 may be saved in the reference picture buffer 190.

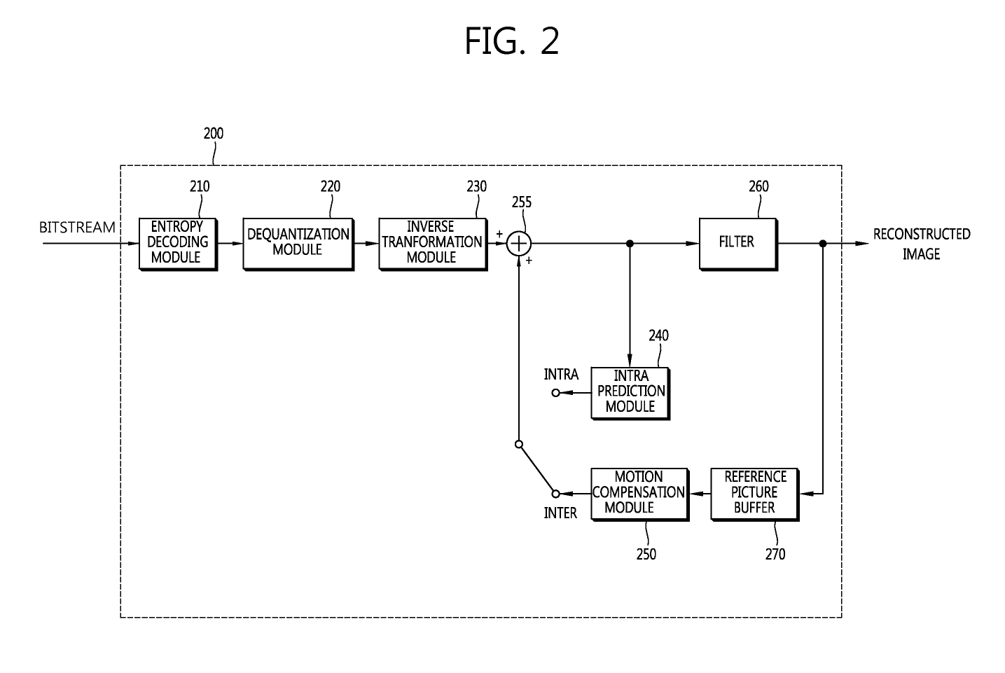

FIG. 2 is a block diagram illustrating the configuration of the video decoding apparatus according to an embodiment.

The scalable video encoding/decoding apparatus may be implemented by extension of the video encoding/decoding apparatus for the single-layer structure.

FIG. 2 shows an embodiment of the video decoding apparatus which is applicable to the multi-layer structure, that is, able to provide scalability.

Referring to FIG. 2, the video decoding apparatus 200 includes an entropy decoding module 210, an dequantization module 220, an inverse transformation module 230, an intra prediction module 240, an inter prediction module 250, a filter module 260 and a reference picture buffer 270.

The video decoding apparatus 200 may perform decoding in the intra mode or the inter mode after being input the bitstream which is output from the encoding apparatus and then output reconstruction images, that is, the images reconstructed.

In case of the intra mode, the switch is switched for the intra prediction, and the switch is switched for the inter prediction in case of the inter mode.

The video decoding apparatus 200 may generate reconstruction blocks, that is, the blocks reconstructed by obtaining residual block which is reconstructed from the bitstream input and generating prediction block, then by adding the residual block reconstructed and the prediction block.

The entropy decoding module 210 may output quantized coefficient and syntax element and the like by entropy decoding the bitstream input according to the probability distribution.

The quantized coefficient may be inversely quantized at the dequantization module 220 and may be inversely transformed at the inverse transformation module 230. The residual block reconstructed may be generated by inversely quantizing/inversely transform the quantized coefficient.

In case of the intra mode, the intra prediction module 240 may perform the spatial prediction by using the pixel value of the block which is already decoded around the current block, and may generate the prediction block for the current block.

In case of the inter mode, the inter prediction module 250 may generate the prediction block for the current block by performing the motion compensation using the reference picture stored in the motion vector and the reference picture buffer 270.

In case of the multi-layer structure, the inter prediction which is applied to the inter mode may include the inter-layer prediction. The inter prediction module 250 may construct the inter-layer reference picture by sampling the picture of the reference layer, and may perform the inter-layer prediction by including the inter-layer reference picture in the reference picture list. The relation of the reference among layers may be signaled through the information that specifies the dependence among layers.

Meanwhile, in case that the current layer picture and the reference layer picture have the same size, the sampling which is applied to the reference layer picture may signify the sample copy from the reference layer picture or the generation of the reference sample by interpolation. In case that the resolution of the current layer picture and that of the reference layer picture are different, the sampling which is applied to the reference layer picture may imply up-sampling.

For example, in this time, as the case of the resolution among layers being different, if the inter-layer prediction is applied among the layers that support the scalability for the resolution, the inter-layer reference picture may be constructed by up-sampling the reconstructed picture of the reference layer.

In this time, the information that specifies the layer to which the picture used as the inter-layer reference picture belongs may be transmitted from the encoding apparatus to the decoding apparatus.

Also, the layer which is referred in the inter-layer prediction, that is, the picture which is used for the prediction of the current block in the reference layer may be the picture of the same Access Unit (AU) as the current picture (the prediction target picture in the current layer).

The reconstructed residual block and the prediction block are added by the adding module 255, and then the reconstruction block is generated. In other word, the reconstructed sample and the reconstructed picture are generated by adding the residual sample and the prediction sample.

The reconstructed picture is filtered in the filter module 260. The filter module 260 may apply at least one of the deblocking filter, the SAO and the ALF to the reconstruction block or the reconstruction picture. The filter module 260 outputs the reconstructed picture which is modified and filtered. The reconstruction image may be saved in the reference picture buffer 270 used for inter prediction.

Also, the image decoding apparatus 200 may further include a parsing module, which is not shown, that is parsing the information in relation to the images encoded which are included in the bitstream. The parsing module may include the entropy decoding module 210, or may be included in the entropy decoding module 210. The parsing module may also be implemented as an element of the decoding module.

Although it is described that one encoding apparatus/decoding apparatus handles all of the encoding/decoding processes for the multi-layer in FIG. 1 and FIG. 2, which is only for the convenience of description, and the encoding/decoding apparatus may be constructed by each layer.

In this case, the encoding/decoding apparatus of the higher layer may perform encoding/decoding of the corresponding higher layer by using the information of the higher layer and the information for the lower layer. For example, the prediction module (inter prediction module) of the higher layer may perform the intra prediction or the inter prediction for the current block by using the pixel information or the picture information of the higher layer, or may perform the inter prediction (inter-layer prediction) for the current block of the higher layer by receiving and using the reconstructed picture information from the lower layer. Here, although only the prediction among the layers is described as an example, the encoding/decoding apparatus may perform encoding/decoding for the current layer by using the information of the other layer regardless of being constructed by each layer or constructed to handle multi-layers by one apparatus.

In the present invention, the layer may include a view. In this case, the inter-layer prediction may be performed by using the information of the other layer among the layers which are specified as having dependency by the information which specifies the dependency among layers, not performed in the way of the prediction of the higher layer by simply using the lower layer information.

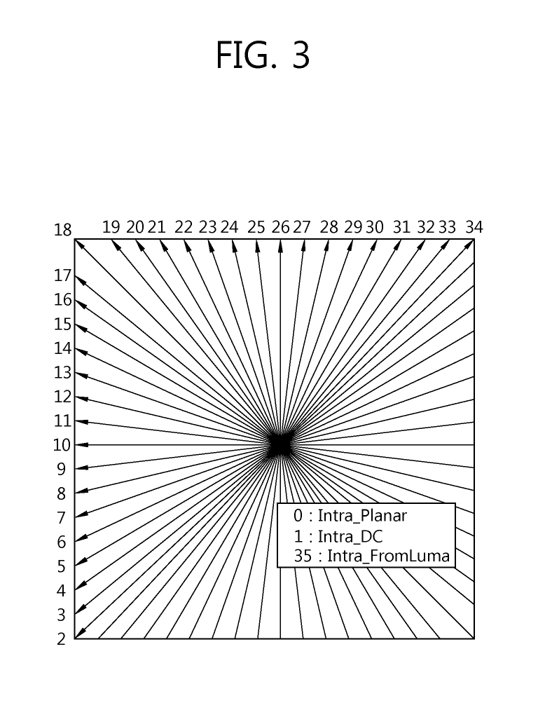

FIG. 3 is a drawing for describing an embodiment of the process of intra picture prediction.

The number of the intra picture prediction mode may be fixed to 35 EA regardless of the size of the prediction block. In this case, the prediction mode may be made up of two non-directional modes (DC, Planar) and thirty three directional modes. In this time, the number of the prediction mode may vary depending on whether the color component is luminance signal (luma) or chrominance signal (chroma). The prediction block may have square form such as 4×4, 8×8, 16×16, 32×32, 64×64 and etc. The unit of the prediction block may be at least one size of the Coding Block (CB), Prediction Block (PB) and Transform Block (TB). The intra picture encoding/decoding may be performed by using the sample value or the coding parameter which is included in the reconstructed block around.

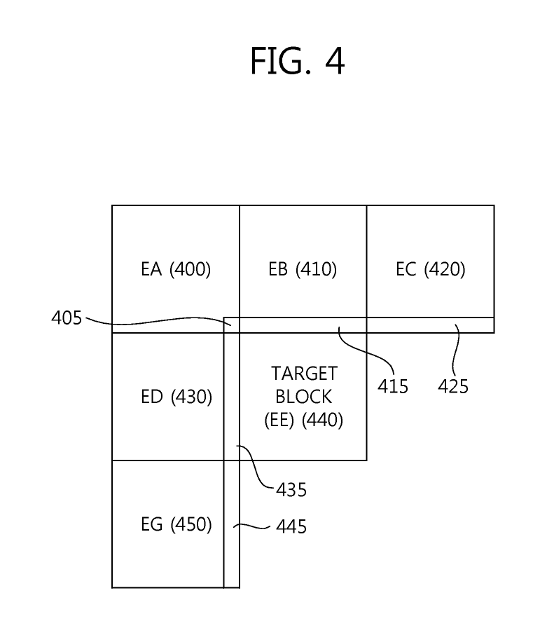

FIG. 4 is a drawing for describing an embodiment of the process of the intra picture prediction.

The reconstructed block around the current block may be block EA 400, EB 410, EC 420, ED 430 or EG 450 according to the order of encoding/decoding, and the sample value that corresponds to ‘above 415’, ‘above_left 405’, ‘left 435’ and ‘bottom_left 445’ may be a reference sample which is used for the intra picture prediction of the target block 440. Also, the coding parameter may be at least one of coding mode (intra picture or inter picture), intra picture prediction mode, inter picture prediction mode, block size, quantization parameter (QP) and Coded Block Flag (CBF).

Each block may be divided into smaller block. Even in this case, the prediction may be performed by using the sample value or the encoding parameter that corresponds to each of the divided blocks.

The filter may be applied for the reconstructed reference sample around which is used for the intra picture prediction. In this time, the filter may be adaptively applied according to the size of the target block or the intra picture prediction mode.

The filter may be applied to the sample located on the boundary of the predicted block after the intra picture prediction being performed. For example, after performing prediction for the target block in FIG. 4, the filter may be applied to the sample inside the target block located on the boundary of ‘above 410’ and ‘left 430’, and the filter is adaptively applied or which sample is applied may depend on the intra picture prediction mode.

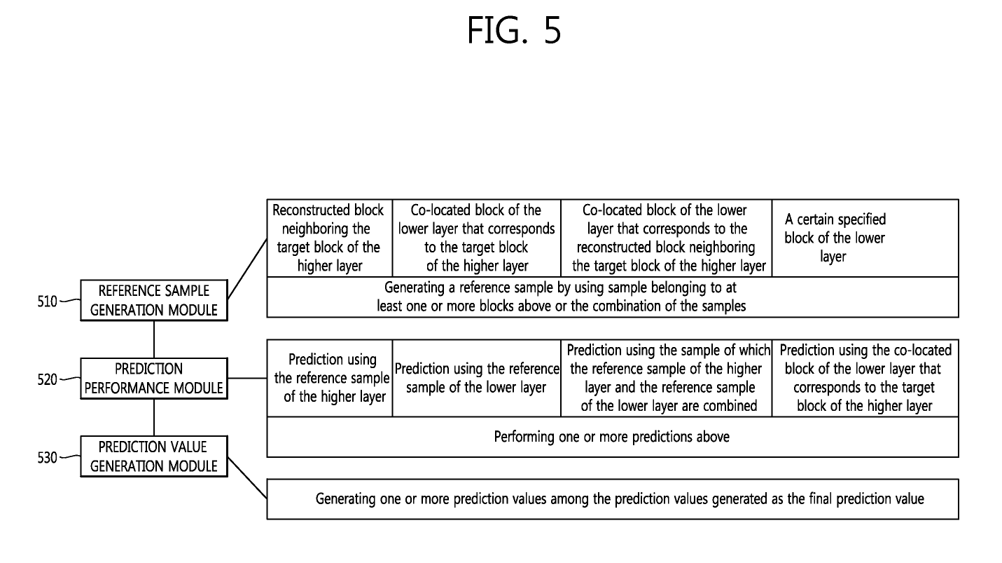

FIG. 5 is a block diagram illustrating the image decoding apparatus according to an embodiment.

The image decoding apparatus according to an embodiment of the present invention includes a reference sample generation module 510, a prediction performance module 520 and a prediction value generation module 530.

The reference sample generation module 510 is a device that uses the intra picture prediction which is combined between layers, and generates a reference sample by using sample belonging to at least one or more blocks out of the sample which is included in the reconstructed block neighboring the target block of the higher layer, the sample which is included in the co-located block of the lower layer that corresponds to the target block of the higher layer, the sample which is included in the co-located block of the lower layer that corresponds to the reconstructed block neighboring the target block of the higher layer, and the sample which is included in a certain specified block of the lower layer.

The prediction performance module 520 generates the prediction value for the target block by using the reference sample.

The prediction value generation module 530 generates the final prediction value for the prediction target block by using the prediction value.

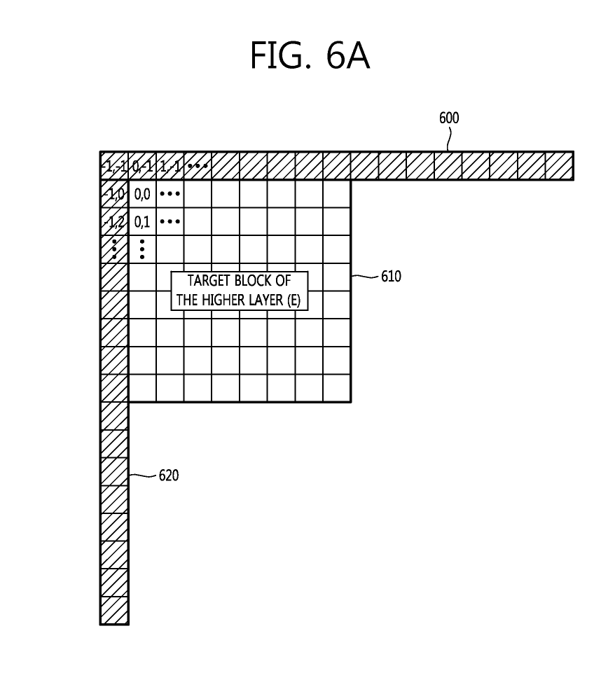

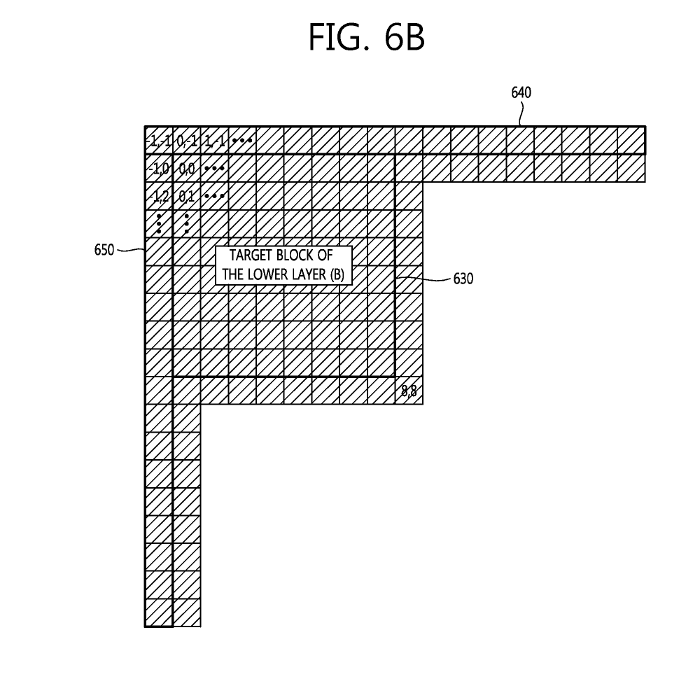

FIG. 6 is a schematic view illustrating briefly the operation of the reference sample generation module that performs prediction of the target block according to an embodiment of the present invention.

The reference sample generation module 510 may generate the reference sample for predicting the target block for encoding/decoding of the higher layer. In this time, the availability of the reference sample may be determined, and the sample which is not available may be padded by the available sample.

Also, the filter may be applied for the reference sample generated. Whether the filter is applied may be adaptively determined according to the size of the target block or the intra picture prediction mode.

Hereinafter, the embodiment will be described with the example of the block having the size of 8×8 as shown in FIG. 6 for the convenience of description and for better understanding of the invention. In the present specification, pE[x, y] may represent the sample value which is reconstructed at the location of [x, y] of the higher layer, and pB[x, y] may represent the sample value which is reconstructed at the location of [x, y] of the lower layer. Also, the shaded samples may be the samples of being reconstructed and of which sample value exists.

As an embodiment of the present invention, the reference sample generation module 510 may generate the reference sample by using the sample which is included in the reconstructed block neighboring the target block of the higher layer.

For example, the reference sample generation module 510 may generate the reference sample by using one or more samples which is located on pE[x, −1] (x=−1˜15) 600 and pE[−1, y] (y=0˜15) 620 of the higher layer target block 610 as shown in FIG. 6. That is, the reference sample generation module 510 may generate the reference sample in the form of the same as the reference sample which is used for the existing intra picture prediction.

According to another embodiment of the present invention, the reference sample may be generated by using the sample which is included in the co-located block 630 of the lower layer that corresponds to the target block 610 of the higher layer. For example, in case that all samples of the co-located block 630 of the lower layer are reconstructed and exist, the reference sample may be generated by using one or more samples located at pB[x, y] (x, y=0˜7) as shown in FIG. 6.

According to another embodiment of the present invention, the reference sample may be generated by using the sample which is included in the co-located block 630 of the lower layer that corresponds to the reconstructed block neighboring the target block of the higher layer. For example, the reference sample may be generated by using one or more samples located at pB[x, −1] (x=−1˜15) 640 and pB[−1, y] (y=0˜15) 650 that corresponds to the block neighboring the co-located block 630 of the lower layer as shown in FIG. 6.

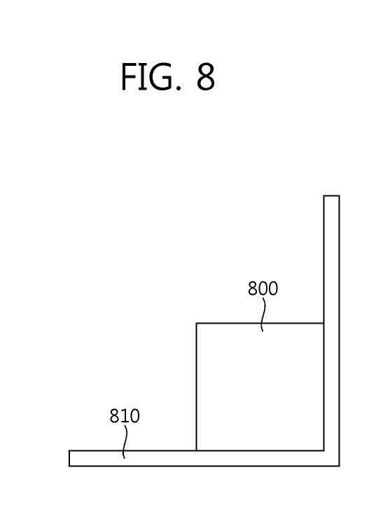

According to another embodiment of the present invention, the reference sample may be generated by using the sample which is included in a certain specified block of the lower layer. For example, in case that all samples of the lower layer are reconstructed and exist shown in FIG. 6, the reference sample may be generated by using one or more samples located at pB[x, 8] (x=−8˜8) and pB[8, y] (y=−8˜7). That is, the reference sample may be generated in the identical form with FIG. 8.

Additionally, the reference sample may be generated by the combination of the samples above. In this case, the combination may imply to combine more than two values by performing operations such as addition, subtraction, multiplication, division, shift, and so on. In this time, the samples may be combined by differently applying weight on each value, and the reference sample value combined may be represented as pF[x, y].

For example, the combined reference sample may be generated by the difference between the reference sample which is generated by using the sample which is included in the reconstructed block neighboring the target block 610 of the higher layer, and the reference sample which is generated by using the sample which is included in the co-located block of the lower layer that corresponds to the reconstructed block neighboring the target block 610 of the higher layer.

This is represented as Equation 1 and Equation 2 in particular.

pF[x,y]=pE[x,y]−pB[x,y],(x=−1˜15,y=−1;x=−1,y=0˜15) <Equation 1>

pF[x,y]=pB[x,y]−pE[x,y],(x=−1˜15,y=−1;x=−1,y=0˜15) <Equation 2>

For example, the combined reference sample may be generated by the mean value of the reference samples which is generated by using the sample which is included in the reconstructed block neighboring the target block 610 of the higher layer, and the reference sample which is generated by using the sample which is included in the co-located block of the lower layer that corresponds to the reconstructed block neighboring the target block 610 of the higher layer.

This is represented as Equation 3 in particular.

pF[x,y]=(pE[x,y]+pB[x,y])>>1,(x=−1˜15,y=−1;x=−1,y=0˜15) <Equation 3>

Meanwhile, in case that the reference sample is generated by using the lower layer block or the combined reference sample is generated such as (1) the case that the reference sample is generated by using the sample which is included in the co-located block 630 of the lower layer that corresponds to the target block of the higher layer, (2) the case that the reference sample is generated by using the sample which is included in the co-located block of the lower layer that corresponds to the reconstructed block neighboring the target block 610 of the higher layer, (3) the case that the reference sample is generated by using the sample which is included in a certain specific block of the lower layer, the filter may not be applied to the reference sample above.

The prediction performance module 520 may perform intra picture prediction by using the reference sample which is generated in the reference sample generation module 510. In this time, the prediction performance module 520 may perform prediction by using the prediction method, such as the DC prediction, the Planar prediction, Angular prediction, and the like which are the common method of the intra picture prediction as shown in FIG. 3. Also, the prediction performance module 520 may also perform the prediction that uses the reconstructed sample value of the lower layer as a prediction value (for example, IntraBL, etc.).

Also, prediction performance module 520 may apply filter for the prediction samples which are located at the boundary of the predicted block and the reference sample. Whether the filter is applied may be adaptively determined according to the size of the target block or the intra picture mode. For example, the prediction performance module 520 may apply filter for the boundary sample of the DC prediction or the horizontally/vertically predicted block.

As an embodiment of the present invention, the prediction performance module 520 may perform prediction by using the reference sample of the higher layer. For example, the prediction performance module 520 may perform the intra picture prediction for the target block with the reference sample generated by using the sample which is included in the reconstructed block neighboring the target block of the higher layer. In this time, the value predicted at the location (x, y) may be represented as predSamplesE[x, y].

As another embodiment of the present invention, the prediction performance module 520 may perform prediction by using the reference sample of the lower layer. For example, the intra picture prediction for the target block which is performed by the prediction performance module 520 may be performed by using (1) the reference sample which is generated by using the sample which is included in the co-located block 630 of the lower layer that corresponds to the target block 610 of the higher layer, (2) the reference sample which is generated by using the sample which is included in the co-located block of the lower layer that corresponds to the reconstructed block neighboring the target block 610 of the higher layer, or (3) the reference sample which is generated by using the sample which is included in a certain specific block of the lower layer. In this time, the value predicted at the location (x, y) may be represented as predSamplesB[x, y].

As another embodiment of the present invention, the prediction performance module 520 may perform prediction by using the reference sample of which the reference sample of the higher layer and the reference sample of the lower layer are combined. For example, the prediction performance module 520 may generate the combined reference sample by the difference or the mean value of the case that the reference sample is generated by using the sample which is included in the reconstructed block neighboring the target block of the higher layer and the case that the reference sample is generated by using the sample which is included in the co-located block of the lower layer that corresponds to the reconstructed block neighboring the target block of the higher layer, respectively and may perform the intra picture prediction using the reference sample combined. In this time, the value predicted at the location (x, y) may be represented by predSamplesC[x, y].

As another embodiment of the present invention, the prediction performance module 520 may generate the co-located block of the lower layer that corresponds to the target block of the higher layer as the prediction block. That is, like the methods described above, the prediction performance module 520 may not perform prediction using the reference sample but use the value of the co-located block of the lower layer as the prediction value. For example, the prediction performance module 520 may set the co-located block of the lower layer with the size of 8×8 as the prediction value for the co-located block of the higher layer. In this case, the prediction method applied may also be referred to IntraBL prediction. In this time, the value predicted at the location (x, y) may be represented as predSampleslntraBL[x, y].

Meanwhile, in case that the intra picture prediction is performed by using the reference sample of the lower layer or the combined reference sample such as (1) the case that the prediction is performed by using the reference sample of the lower layer, (2) the case that the prediction is performed by using the reference sample of which the reference sample of the higher layer and the reference sample of the lower layer are combined, (3) the case of generating the co-located block of the lower layer that corresponds to the target block of the higher layer as the prediction block, the filter may not be applied to the boundary sample of the predicted block.

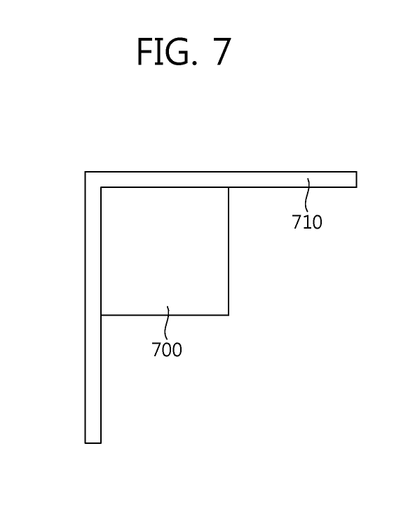

FIG. 7 shows an embodiment of performing the intra picture prediction by using the reference sample which is generated according to the present invention. In case of performing the prediction by using the reference sample of the lower layer in the prediction performance module 520, the intra picture prediction may be performed by using the reference sample which is generated by using the sample included in the target block 710 of the lower layer that corresponds to the reconstructed block (600, 620) neighboring the target block 610 of the higher layer.

In this time, the sample included in the co-located block 710 of the lower layer that corresponds to the reconstructed block 600 and 620 neighboring the target block 610 of the higher layer may generate the reference sample by using one or more samples located at pB[x, −1] (x=−1˜15) and pB[−1, y] (y=0˜15) 710 that corresponds to the boundary of the co-located block of the lower layer.

FIG. 8 shows another embodiment of performing the intra picture prediction by using the reference sample which is generated according to the present invention.

The intra picture prediction may be performed by using the reference sample which is generated by using the sample included in a certain specific block of the lower layer in the prediction performance module 520.

In this time, in case that all samples of the lower layer are reconstructed and exist, the reference sample may be generated by using one or more samples located at pB[x, 8] (x=−8˜8) and pB[8, y] (y=−8˜7) 810.

In this time, if the block shown in FIG. 8 is rotated by 180 degrees, it has the identical shape with FIG. 7. The co-located block 700 of the lower layer shown in FIG. 7 corresponds to the co-located block 800 of the lower layer shown in FIG. 8. If the block 810 neighboring the co-located block of the lower layer shown in FIG. 8 is rotated by 180 degrees, it becomes the block 710 neighboring the co-located block of the lower layer shown in FIG. 7. Accordingly, the prediction performance module 520 may predict with the common intra picture prediction method.

The prediction value generation module 530 may generate the final prediction value from the value combining one or more prediction values among the prediction values which are generated through the prediction performance module 520. In this time, each prediction value may be combined by setting with different weighting. Here, the final prediction value at the location (x, y) may be represented as predSamplesF[x, y]. The horizontal and vertical size of the block may be represented as N, and thus represented as x=0, . . . , N−1, y=0, . . . , N−1.

As an embodiment of the method of generating the prediction value according to the present invention, there exists a method of determining one prediction value as the final prediction value in the prediction value generation module 530. In this time, the prediction value generation module 530 may determine the final prediction value for the cases such as the following (1) to (3) cases according to the reference sample used.

(1) The prediction value generation module 530 may determine the value which is predicted by using the reference sample of the higher layer as the final prediction value. This is represented as Equation 4 in particular.

predSamplesF[x,y]=predSamplesE[0],(x,y=0˜N−1) <Equation 4>

(2) The prediction value generation module 530 may determine the value which is predicted by using the reference sample combined by the mean value of the reference sample of the higher layer and the reference sample of the lower layer as the final prediction value. This is represented as Equation 5 in particular.

predSamplesF[x,y]=predSamplesC[x,y],(x,y=0˜N−1) <Equation 5>

(3) The prediction value generation module 530 may determine the value which is predicted by co-located block of the lower layer as the final prediction value. Since the co-located block may have the value which is the most approximate to the original value of the prediction target block, the encoding efficiency may be increased by decreasing the prediction error. This is represented as Equation 6 in particular.

predSamplesF[x,y]=predSampleslntraBL[x,y],(x,y=0˜N−1) <Equation 6>

As another embodiment of the method of generating the prediction value according to the present invention, there exists a method of determining the final prediction value by combining two prediction values in the prediction value generation module 530. In this time, the prediction value generation module 530 may determine the final prediction value for the cases such as the following (1) to (3) cases according to the reference sample used.

(1) The prediction value generation module 530 may determine the final prediction value by combining the value which is predicted by using the reference sample of the higher layer and the value which is predicted by using the reference sample of the lower layer. This is represented as Equation 7 in particular.

predSamplesF[x,y]=(W*predSamplesE[x,y]+(2n−W)*predSamplesB[x,y]+2ⁿ⁻¹)>>n,(x,y=0˜N−1) <Equation 7>

In this time, ‘W’ and ‘n’ are weighting factors. In case that the weighting factor is 1:1 (W=1 and n=1), the final prediction value is shown as Equation 8.

predSamplesF[x,y]=(predSamplesE[x,y]+predSamplesB[x,y]+1)>>1,(x,y=0˜N−1) <Equation 8>

In this time, in case that the weighting is 3:1 (W=3 and n=2), the final prediction value is shown as Equation 9.

predSamplesF[x,y]=(3*predSamplesE[x,y]+predSamplesB[x,y]+2)>>2,(x,y=0˜N−1) <Equation 9>

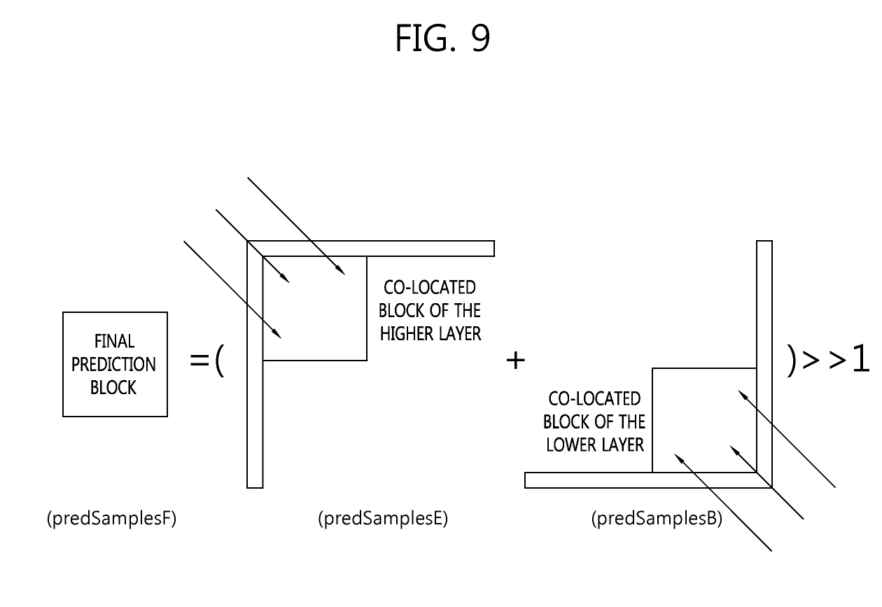

FIG. 9 is a drawing briefly describing an embodiment of generating the final prediction value by combining the prediction value generated according to the present invention.

As described above, in case of determining the final prediction value by combining two prediction values, the reference sample of the lower layer may be used together with the reference sample of the higher layer. In this time, the reference sample of the lower layer generated by using the sample which is included in a certain specific block of the lower layer as shown in FIG. 8.

Referring to FIG. 9, the prediction value generation module 530 may generate the final prediction value by combining the reference sample of the upper end and the left of the co-located block of the higher layer which is selected according to the prediction mode in the higher layer, and the reference sample of the lower end and the right of the co-located block of the lower layer which is selected according to the prediction mode in the lower layer.

Through this, the predicted effect is obtained through the right and left and top and bottom and four surfaces, and the encoding efficiency may be increased.

FIG. 9 a brief schematic diagram illustrating the method of generating the final prediction value by combining the reference sample of the upper end and the left of the co-located block of the higher layer and the reference sample of the lower end and the right of the co-located block of the lower layer.

Referring to FIG. 9, the mode which is the same as the intra picture prediction mode of the higher layer may be used in the lower layer. As an example of the usage relation of the higher layer and the lower layer, considering there was the reversal relation, it may be known that the direction of the prediction mode which is used in the lower layer is symmetrical to the direction of the prediction mode which is used in the higher layer.

For example, the prediction value generation module 530 may determine the final prediction value by combining the value which is predicted by using the reference sample of the higher layer and the value which is predicted by using the reference sample of the lower layer. This is represented as Equation 10 in particular.

predSamplesF[x,y]=(predSampleslntraBL[x,y]+predSamplesE[x,y]+1)>>1,(x,y=0˜N−1) <Equation 10>

Different from the example of Equation 10, the weighting may be added to the reference sample of the lower layer. This is represented as Equation 11 in particular. In Equation 11, the example of the weighting is 3:1 will be described for the convenience of description.

predSamplesF[x,y]=(3*predSamplesIntraBL[x,y]+predSamplesE[x,y]+2)>>2,(x,y=0˜N−1) <Equation 11>

Meanwhile, in the example of FIG. 9, the prediction value generation module 530 may also determine the final prediction value by combining the value predicted by using the reference sample which is combined by the difference of the reference sample of the higher layer and the reference sample of the lower layer, and the value predicted by the co-located block of the lower layer that corresponds to the target block of the higher layer.

That is, in this case, the prediction value using the combined reference sample may correspond to the error between the higher layer and the lower layer. The final prediction value becomes close to the original sample of the target block of the higher layer by adding the error to the co-located block of the lower layer, which decreases the residual, and then the encoding efficiency may be increased.

This is represented as Equation 12 in particular.

predSamplesF[x,y]=predSampleslntraBL[x,y]+predSamplesC[x,y],(x,y=0˜N−1) <Equation 12>

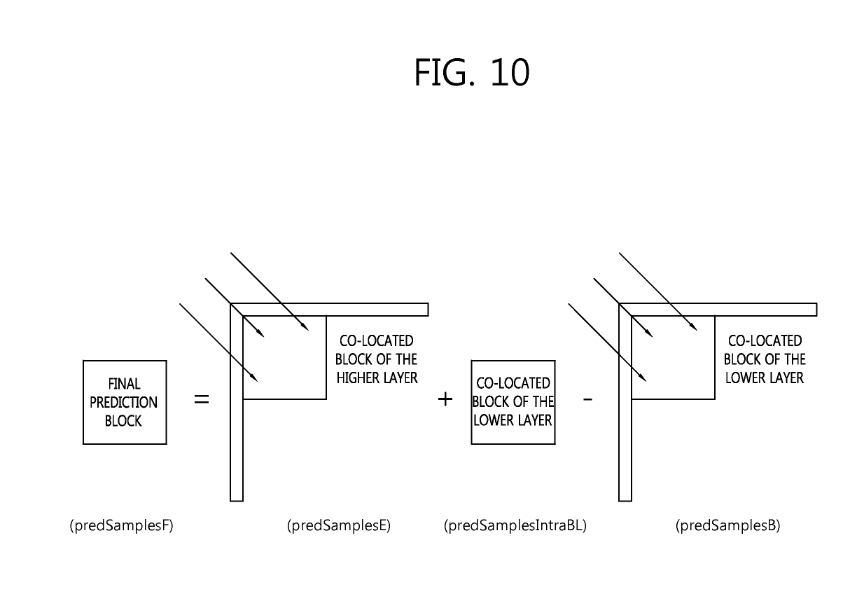

FIG. 10 shows another embodiment of generating the final prediction value by combining the prediction value which is generated according to the present invention.

According to the example of FIG. 10, the final prediction value may be determined by combining three prediction values.

For example, the prediction value generation module 530 may also determine the final prediction value by adding intermediate residual to the value which is predicted by using the reference sample of the higher layer after obtaining the intermediate residual through the difference between the value which is predicted by using the reference sample of the lower layer and the value which is predicted by the co-located block of the lower layer that corresponds to the target block of the higher layer. That is, the prediction value generation module 530 makes the final prediction value become close to the original sample of the target block of the higher layer by adding the intermediate residual which is generated from the lower layer to the value which is predicted by using the reference sample of the higher layer, which decreases the residual, and then the encoding efficiency may be increased.

FIG. 10 is briefly describing the method of determining the final prediction value by adding the intermediate residual to the value which is predicted by using the reference sample of the higher layer after obtaining the intermediate residual through the difference between the value which is predicted by using the reference sample of the lower layer and the value which is predicted by the co-located block of the lower layer that corresponds to the target block of the higher layer.

This is represented as Equation 13 in particular.

predSamplesF[x,y]=predSamplesE[x,y]+(predSampleslntraBL[x,y]−predSamplesB[x,y]),(x,y=0˜N−1) <Equation 13>

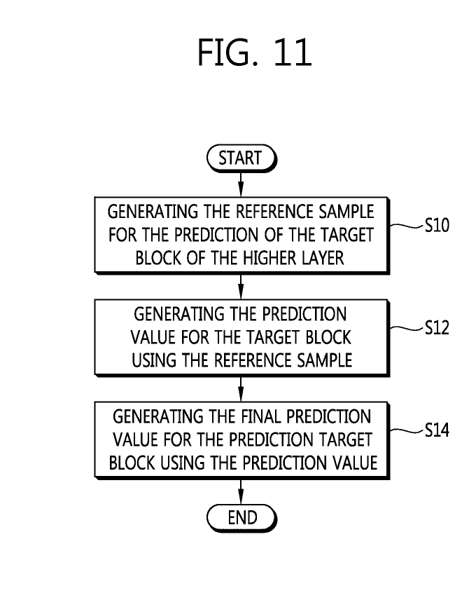

FIG. 11 is a flowchart describing an embodiment of the image encoding and/or decoding method using the intra picture prediction which is combined between layers according to the present invention.

The operation performed in each step of FIG. 11 may be performed by each units of the image decoding apparatus according to the present invention, for example, the reference sample generation module, the prediction performance module or the prediction value generation module. In the example of FIG. 11, it will be described that the operation is performed by the image decoding apparatus for the convenience of description.

Referring to FIG. 11, the image decoding apparatus generates the reference sample for the prediction of the target block of the higher layer (step, S10).

The decoding apparatus generates the reference sample by using at least one of (1) the sample which is included in the reconstructed block neighboring the target block of the higher layer, (2) the sample which is included in the co-located block of the lower layer that corresponds to the target block of the higher layer, (3) the sample which is included in the co-located block of the lower layer that corresponds to the reconstructed block neighboring the target block of the higher layer, and (4) the sample which is included in a certain specific block of the lower layer.

The detailed method of generating the reference sample which is to be used for the prediction of the target block by using the reference sample of the higher layer and the reference sample of the lower layer is the same as described by referring to FIGS. 6a, 6b, and etc above.

The image decoding apparatus performs generating the prediction value for the target block using the reference sample (step, S12).

The image decoding apparatus may perform the intra picture prediction by using the reference sample which is generated in step, S10. In this time, the image decoding apparatus may perform the DC prediction, the Planar prediction, the Angular prediction, and the like, and may also perform the IntraBL prediction that uses the reconstructed sample value of the lower layer as the prediction value.

Also, the image decoding apparatus may apply filter for the prediction samples which is located on the boundary between the predicted block and the reference sample.

The detailed description of the method of performing prediction and applying filter are the same as described by the embodiments above.

The image decoding apparatus generates the final prediction value for the prediction target block using the prediction value (step, S14).

The image decoding apparatus generates the value combining one or more prediction values among the prediction values which is generated through step S12 as the final prediction value.

In this time, the image decoding apparatus may also combine the prediction values by applying weighting (W).

The detailed description of the method for generating the final prediction value is the same as described by the embodiments above.

What is claimed is:

1. Apparatus for decoding image using an inter-layer combined intra prediction, the apparatus comprising:
a reference sample generation module generating a reference sample by using at least one of samples which is included in the reconstructed block neighboring the target block of the higher layer, a sample which is included in the co-located block of the lower layer that corresponds to the target block of the higher layer, a sample which is included in the co-located block of the lower layer that corresponds to the reconstructed block neighboring the target block of the higher layer, and a sample which is included in a certain specific block of the lower layer;
a prediction performance module generating a prediction value for the target block using the reference sample; and
a prediction value generation module generating a final prediction value for the prediction target block using the prediction value.

2. The apparatus of claim 1, wherein a filter is applied to the reference sample in case that the reference sample is generated by not using the block of the lower layer, and
wherein the filter is not applied to the reference sample in case that the reference sample is generated by using the block of the lower layer.

3. The apparatus of claim 1, wherein the reference sample generation module generates the reference sample according to combination of the samples.

4. The apparatus of claim 3, wherein the combination of the samples is performed by combining two or more samples by applying an operation including addition, subtraction, multiplication, division and shift.

5. The apparatus of claim 3, wherein the samples are combined by differently applying weighting to each sample value in case of combining the samples.

6. The apparatus of claim 3, wherein a filter is not applied to the reference sample generated in case of generating the reference sample according to the combination of the samples.

7. The apparatus of claim 1, wherein the prediction performance module performs one or more predictions including a prediction using the reference sample of the higher layer, a prediction using the reference sample of the lower layer, a prediction using the sample which is generated to combine the reference sample of the higher layer and the reference sample of the lower layer, and a prediction using the co-located block of the lower layer that corresponds to the target block of the higher layer.

8. The apparatus of claim 7, wherein a filter is not applied to the boundary prediction value of the block which is predicted in case of using the reference sample of the lower layer or in case of using the combined reference sample, in case of generating the reference sample by combining two or more samples.

9. The apparatus of claim 7, wherein the prediction value generation module generates the final prediction value by combining two or more prediction value which is generated in the prediction performance module.

10. The apparatus of claim 9, wherein the prediction value generation module combines each prediction value by differently applying weighting.

11. Method for decoding image using an inter-layer combined intra prediction, the method comprising:
generating a reference sample by using at least one of samples which is included in the reconstructed block neighboring the target block of the higher layer, a sample which is included in the co-located block of the lower layer that corresponds to the target block of the higher layer, a sample which is included in the co-located block of the lower layer that corresponds to the reconstructed block neighboring the target block of the higher layer, and a sample which is included in a certain specific block of the lower layer;
performing prediction by generating a prediction value for the target block using the reference sample; and
generating a final prediction value for the prediction target block using the prediction value.

12. The method of claim 11, wherein generating the reference sample performs:
applying a filter to the reference sample in case that the reference sample is generated by not using the block of the lower layer, and
not applying the filter to the reference sample in case that the reference sample is generated by using the block of the lower layer.

13. The method of claim 11, wherein generating the reference sample generates the reference sample by the combination of the samples.

14. The method of claim 13, wherein the combination of the samples is performed by combining two or more samples by applying an operation including addition, subtraction, multiplication, division and shift.

15. The method of claim 13, wherein the samples are combined by differently applying weighting to each sample value in case of combining the samples.

16. The method of claim 13, wherein a filter is not applied to the reference sample in case of generating the reference sample by combining two or more samples.

17. The method of claim 10, wherein performing the prediction performs one or more predictions including a prediction using the reference sample of the higher layer, a prediction using the reference sample of the lower layer, a prediction using the sample which is generated to combine the reference sample of the higher layer and the reference sample of the lower layer, and a prediction using the co-located block of the lower layer that corresponds to the target block of the higher layer.

18. The method of claim 17, wherein a filter is not applied to the boundary prediction value of the block which is predicted in case of using the reference sample of the lower layer or in case of using the combined reference sample.

19. The method of claim 17, wherein performing the prediction generates the final prediction value by combining two or more prediction value which is generated in the prediction performance module.

20. The method of claim 19, wherein combining two or more prediction values combines each prediction value by differently applying weighting.
